(19) United States
(12) Patent Application Publication
(10) Pub. No.: US 2003/0237100 A1
(43) Pub. Date: Dec. 25, 2003

(54) Information display system

(75) Inventor: Tony E. Piotrowski, Wayne, NJ (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/176,231

(22) Filed: Jun. 20, 2002

(51) Int. Cl. H04N 7/16; G06F 3/00; H04N 5/445; H04N 11/00; H04N 7/084; H04N 7/087; H04N 7/08; H04N 7/00; G06F 13/00

(52) U.S. Cl. 725/135; 348/563; 348/468; 348/461; 725/139; 348/473

(57) ABSTRACT

A system and method are disclosed for automatically displaying program guide information for television programs using information from the Extended Data Services (EDS) or similar type data services. The system allows for the automatic display of program related information automatically as a user scrolls (surfs) through various program channels. The information is displayed in an unobtrusive manner.

### FIELD OF THE INVENTION

The invention relates to a system and method controlling and providing enhanced video/television program display information, in particular, the method and system allow for automatic updating and display of program related information using embedded information within the program signal.

### BACKGROUND OF THE INVENTION

In a conventional television signal, data such as closed captioning and teletext data may be embedded in the television signal along with the audio/visual information of the content program. Closed captioning, for example, is the textual representation of program dialogue that may include other program descriptions. The Closed caption text is typically displayed in a box (subtitling) at the bottom of a television screen (see FIG. 1).

In FIG. 1, a television 100 includes a display screen 110. The closed captioning or teletext information is displayed in a box 120. A drawback of this arrangement is that a portion of a video/television program 130 is blocked from view.

In the United States, closed captioning services and other data services are embedded in line 21 of the vertical blanking interval of the National Television Standards Committee (NTSC) video signal. The information transmitted on line 21 forms various data packets that can be decoded by decoders within the television.

The data signal on line 21 consists of independent data on data channels designated as field 1 and field 2. Each data channel may contain specific types of data packets. These types of data packets include synchronous caption service, non-synchronous use captions, text services and extended data services (EDS).

The text services are data services that are generally not program related.

EDS are additional services that may be used/performed related to a TV program. The EDS data are packetized into categories based upon their type, such as current program information, future program information, length of currently broadcast show, elapsed time since the beginning of the show, program title, content advisory, program description, network name, station ID, time of day, national weather service, and program type. Each of these XDS data types have a different packet length.

For example, as related to the content advisory data packet, the Electronic Industries Association (EIA) defines the four censorship categories and the number of data bits required to transmit the code:

MPAA rating (equivalent to film classifications, e.g. 18, PG, etc.)-3 bits

violence content advisory level-2 bits (which allows for a scale of 0 to 3)

sexual content advisory level-2 bits

mature content advisory level-2 bits.

The Closed Caption (CC) data is extracted from line 21 and a decoder is used to provide subtitling on the display screen. Current CC decoders (such as the SAA5252 decoder sold by Philips Semiconductors) are capable of blanking out all or a portion of the TV picture when switched into CC mode. They also have adequate display features to generate an on screen display (OSD) menu.

Similarly, EDS data is extracted from data interleaved on line 21, field 2, of the vertical blanking interval of a television signal and can be decoded. The data is extracted using data capture circuitry. The EDS data is then processed via a CPU and can be displayed via on screen display (OSD) circuitry. The EDS information, e.g., is displayed in a subtitle box similar to the box 120 in FIG. 1.

However this type of box obscures a portion of the video/television program 130, which is undesirable and annoying. There thus exists in the art a need for improved methods and systems for providing enhanced program related information while not obscuring a portion of the video program.

### SUMMARY OF THE INVENTION

One aspect of the invention is directed to a system for automatically displaying program guide information for television programs using information from the Extended Data Services (EDS). The system allows for the automatic display of program guide-type information automatically as a user scrolls (surfs) through various program channels. The information is displayed in an unobtrusive manner on a display screen.

One embodiment of the invention is directed to a method of providing television program related information to a viewer. The method includes the steps of receiving, by a television, an audio/visual signal including embedded content information, extracting the embedded content information and formatting the embedded content information for display to the viewer. When the viewer changes a current television channel to another television channel, the method automatically displays the formatted content information to the viewer.

Another aspects of the invention are directed to a system and/or a receiver that has features corresponding to the method described above.

These and other features and advantages of the present invention will become more apparent from the accompanying drawings and the following detailed description.

### BRIEF DESCRIPTION OF THE DRAWINGS

FIG. 1 shows a conventional video/television device.

FIG. 2 shows a system in accordance with one embodiment of the present invention.

FIG. 3 shows in block schematic of a receiver system in accordance with another embodiment of the present invention.

FIG. 4 show a flow change of a method in accordance with a preferred embodiment of the invention.

### DETAILED DESCRIPTION OF THE INVENTION

The system shown in FIG. 2 includes a signal/program source 1, a transmission medium 2, and a plurality of receivers 3-1 to 3-n. The program source 1 may be conventional television broadcast equipment, e.g., terrestrial broadcast, satellite broadcast or a cable television source. The program source 1 should also include a closed caption, teletext and/or EDS data inserter. The program source 1 may also be pre-recorded content information such as from a DVD or VHS tape that includes EDS data.

The transmission medium 2 may take any convenient form for example it could be radio waves as broadcast by a terrestrial transmitter or a satellite transmitter or could be a cable network for a cable TV system. The receivers 3-1 to 3-n are connected to the program source 1 via the transmission medium 2.

Another possible program source 1 is a video tape or disc on which a program is recorded for replay by a video tape recorder or a video disc player in which the case the transmission link 2 may be simply the tape recorder or disc player and a cable connecting the tape recorder or disc player to the television receiver.

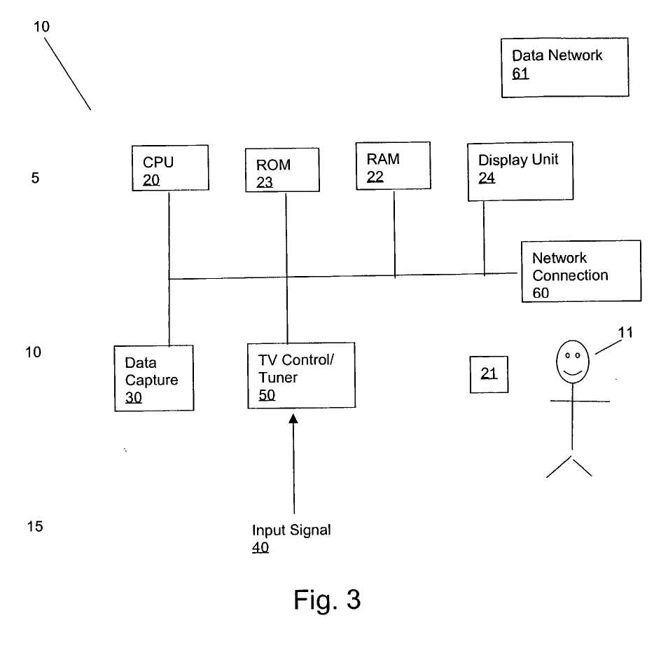

The receiver 3-1 to 3-n should be equipped with extended data services (EDS) of the Closed Captioning (CC) capability or a similar functionality, e.g., teletext. FIG. 3 shows a block diagram of a receiver 10 equipped with CC and EDS capability. A data capture module 30 is configured to receive a composite input signal 40 (i.e., a signal with audio/video information which may also include EDS data) input to a TV control/tuner circuit 50. EDS data (i.e., EDS packets) are extracted from line 21 of the vertical blanking interval in the composite input signal 40. The EDS packet is then processed via a control processor (CPU) 20 executing application software. The CPU 20 may also perform OSD functionality.

In particular, the CPU 20 controls in conventional fashion the operation of the receiver 10. It may receive control instructions from a remote control unit 21 which a viewer 11 uses to select a particular channel for display and selects other functions such as CC display or on screen menu displays.

The CPU 20 receives from the data capture module 30 codes (e.g., EDS data packets) that are present in a received input signal 40. The received input signal 40 is provided from the program source 1. The EDS data represents the program-related information such current channel and time of day. The CPU 20 may store the codes within a memory 22 and/or 23. Input control signals, used to program the ODS, entered by the viewer 11 using the remote control unit 21 may also be stored.

A display unit 24 is used to display the audio/visual information from the input signal 40.

In a preferred embodiment, the functions of the receiver 10 are implemented by computer readable program code executed by the CPU 20. The program code may be stored in the memory 23 or read/downloaded from a memory medium such as a CD-ROM or floppy disk. In other embodiments, hardware circuitry may be used in place of, or in combination with, software instructions to implement the invention. For example, embodiments of the present invention may be implemented on a digital television platform using a Trimedia processor for processing and a television monitor for display. The receiver 10 may also include a network connection 60 for interfacing to a data network 61, such as a variable-bandwidth network or the Internet or the public switched telephone network (PSTN).

Many conventional televisions have a feature in which channel information and/or other information is displayed when the current channel is changed to another channel. This is typically displayed in a corner of the display screen in a semi-transparent format so as not to block the content of the program.

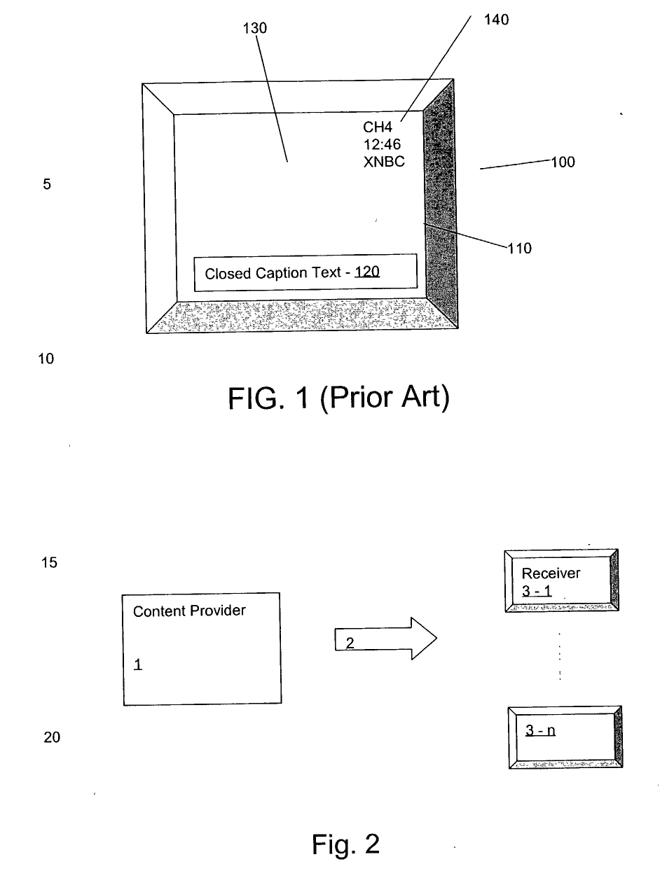

Referring to back to FIG. 1, such channel information and/or other information 140 is shown. In particular, the current channel (i.e., CH 4), the current time (i.e., 12:45) and the current program provider (i.e., XNBC) are shown.

One major drawback of this conventional system, however, is that only a limited amount of information is provided to the viewer. In addition, the information may not be accurate. In this regard, the viewer must manually set the time and/or update network information. If the television loses power, then the time and channel information may be lost and would need to be reset. Moreover, many content providers like cable companies in the US will change/update/modify the content providers that are offered to a viewer. For example, the channel number for a particular content provider (i.e., XNBS) may change when the cable company expands the number of content providers offered to the viewer. Unless the viewer manually updates this information the OSD, the wrong data is displayed to the view when the channel is changed.

One embodiment of the present invention allows program guide information to be automatically updated and displayed to the viewer. For example, the time of day and the content provider identifier (e.g., network or station ID) may be automatically updated and this information stored in the memory 22 or 23 for future use. There is also much more information available to the user. For example, in addition to the channel information (e.g., channel 2 or 4) a variety of other information may also be displayed. This other information may include:

1. current time and date;

2. program name;

3. content provider or station ID (e.g., XNBC);

4. start and end time of current program; and

5. program time remaining.

In practice, the EDS data is extracted. As discussed above, the EDS data already may contain a variety of data that is related to the program being viewed. This EDS data is then processed and formatted automatically to provide the controller 20 so that the can be display. The viewer never needs to manually update any content information regarding the display. Thus, when the viewer 11 changes channels frequently to search for a desired program or show (e.g., channel surfing), the program related information may be automatically displayed to the view 11. The information may also be displayed when requested by the viewer, e.g., by pressing a button or other indicia on the remote control unit 21.

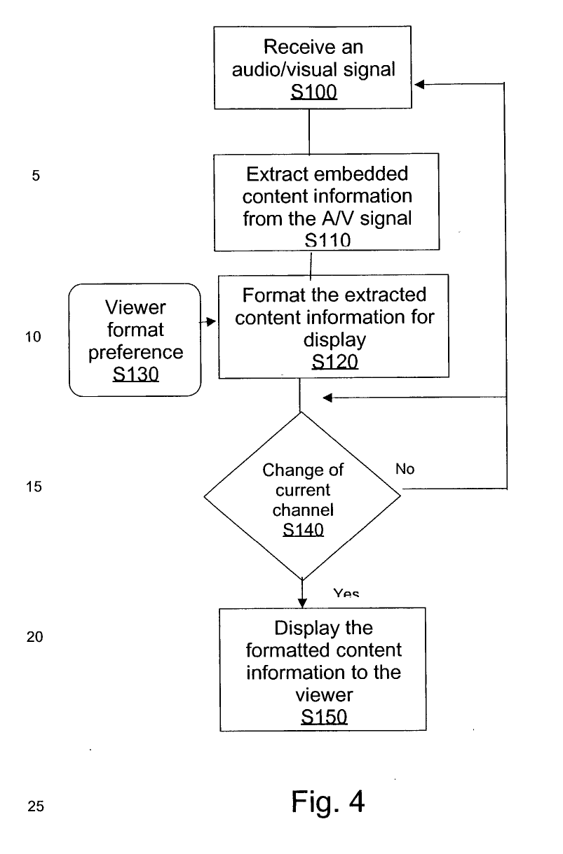

FIG. 4 is a flowchart illustrating one embodiment of the present invention. In step S100, an audio/visual (A/V) signal is received and, in step S110, embedded content information is extracted from the A/V signal. The A/V signal, as discussed above, may be a composite television signal. The extracted content information is formatted in step S120. A pre-selected viewer format preference may be used for the formatting (step S130). A default format may also be used if no viewer format is specified. A change of a current channel to a different channel is detected in step S140. When this happens, the formatted content information is automatically displayed to the viewer in step S150. Otherwise, a loop back to step S140 or step S100 occurs, ether to wait or receive more information from the A/V signal.

The viewer 11 through an OSD menu interface and the remote control unit 21 may customize the format and amount of the information displayed. The viewer 11 may choose a subset of information to be displayed or all EDS data available. The viewer 11 may also choose the type and location of the display, e.g., semi-transparent and in the upper-right hand corners of the display screen. The display information may also be displayed one line at a time and scrollable to access all of the information.

In the present invention, the information displayed (e.g., in step S150) is referred to as an automatic program display (APD) window. It should be understood that the APD window is not the same as the box 120 or subtitle display that is used for Closed Captioning or teletext type information.

It is also noted that one significant different between embodiments of the present invention and conventional Closed Captioning, teletext and EDS services is that the extracted information is used to update parameters that may already be stored in a receiver. For example, conventional television receivers may have a time of day feature. The time of day may be displayed upon request or when a channel is changed. However, the time of day may be incorrect or not programmed so that the display is inaccurate. In one embodiment of the present invention, the time of day is automatically updated or checked using the extracted information from the EDS packet. If there is a difference between the current television time of day and the extracted information, the viewer may be prompted to confirm the automatic change and/or the current television time of day may be automatically updated.

In another embodiment, the receiver 10 may receive automatic updates related to different services offered by the content providers. For example, if a cable company is upgrading or enhancing their cable system (e.g., from analog to digital), cable channels may be added and/or current channels may be moved. In this embodiment, the receiver 10 may receive the new channel information and update various parameters automatically. In this regard, labels that identify particular content providers (e.g., XNBC in FIG. 1) can be automatically updated for the viewer's convenience.

In addition, many conventional televisions have an auto channel search feature that pre-programs the channel “up” and “down” buttons on a remote control to skip over channels that do not have any content. The present invention may be used to automatically update the skip feature to add or delete channels from the skip feature.

All of the information needed for this display can be extracted from the EDS system. The OSD controller, e.g., the controller 20, within the receiver 10 (e.g., a TV or a set-top box) then displays the information to the viewer 11. As discussed above, this may be automatically performed when the viewer 11 changes a program channel.

The viewer 11 may also have the option of displaying additional information for a particular program, e.g., a summery of the program. The viewer 11 may also request future program information related to the current station or channel. This may be requested via the remote control unit 21.

In another embodiment, the receiver 10 may also monitor which content providers 1 or programs that are being watched by the viewer 11. This would be done by recording information such as the program information, e.g., station ID and length of time watched using the EDS data. This can provide real-time program ratings data to the content providers 1 (e.g., Nelson rating-type data). The recorded data can be transferred to a centralized processing location via the network connection 60. For example, the receiver 10 may have two way cable or Internet interface. The data can also be stored in a portable recording medium (e.g., a CD) for future processing.

In another embodiment of the present invention a credit/rebate to the viewer 11 can be granted for allowing the rating-type information to be extracted. This may be done, for example, by cable providers who normally charge a monthly fee for providing cable programming.

While the present invention has been described above in terms of specific embodiments, it is to be understood that the invention is not intended to be confined or limited to the embodiments disclosed herein. For example, various embodiment of the present invention may also be used in conjunction with videocassette recorder (VCRs), Personal Digital Assistants (PDAs), personal or laptop computers, and mobile telephones. Such devices may also be equipped with hardware and software that can receive and process EDS type data packets. Accordingly, the present invention is intended to cover various structures and modifications thereof included within the spirit and scope of the appended claims.

What is claimed is:

1. A method of providing television program related information to a viewer, the method comprising the steps of:
receiving, by a television, an audio/visual signal including embedded content information;
extracting the embedded content information;
formatting the embedded content information for display to the viewer; and
when the viewer changes a current television channel to another television channel, automatically displaying the formatted content information to the viewer.

2. The method according to claim 1, wherein the formatted content information is displayed in an automatic program display (APD) window.

3. The method according to claim 2, wherein the embedded content information includes at least one of current program information, future program information, length of a current program, elapsed time since the beginning of a current program, a program title, a content advisory, a program description, a network/content provider name, a station ID, a time of day, a national weather service, or a program type.

4. The method according to claim 2, wherein the embedded content information is formatted in accordance with a format selected by the viewer.

5. The method according to claim 1, further comprising the step of automatically updating information related to the audio/visual program stored in the television.

7. The method according to claim 5, wherein the updated information is the time of day.

8. The method according to claim 5, wherein the updated information is content provider information such a network name.

9. The method according to claim 1, further comprising the step of extracting the embedded content information audio/visual signal using a data capture module.

10. The method according to claim 1, further comprising the step of recording rating-type information for television programs being viewed.

11. The method according to claim 10, further comprising the step of providing the recorded rating-type information to a content provider via a remote network connection.

12. A system for providing television program related information to a viewer, the system comprising:
a television receiver capable of receiving an audio/visual signal including embedded content information;
a data capture circuit arranged to extract the embedded content information; and
a controller arranged to format the embedded content information for display to the viewer,
wherein when the viewer changes a current television channel to another television channel, the controller automatically displays the formatted content information to the viewer.

13. The system according to claim 12, wherein the data capture module forms part of a closed captioning system.

14. The system according to claim 13, wherein the audio/visual signal is a television program and the embedded content information is an extended data services (EDS) packet that is extracted from line 21 of a vertical blanking internal.

15. The system according to claim 12, wherein the data capture module forms part of a teletext system.

16. A receiver comprising:
means for receiving a television signal including program related data inserted in a vertical blanking interval;
means for extracting the program related data;
means for formatting the extracted program related data for a display; and
means for determining whether a current channel has changed; and
means for automatically displaying the formatted extracted program related data when said means for determining indicated that the current channel has been changed.

17. The receiver according to claim 16, wherein the formatted program related data is displayed in a semi-transparent format.

18. The receiver according to claim 16, wherein the program related data includes at least one of current program information, future program information, length of a current program, elapsed time since the beginning of a current program, a program title, a content advisory, a program description, a network/content provider name, a station ID, a time of day, a national weather service, or a program type.

19. The receiver according to claim 16, further including means for customizing a format and an amount of information to be displayed in accordance with a viewer's preference using an on-screen-display (OSD) menu and a remote control unit.
